(19) United States
(12) Patent Application Publication
(10) Pub. No.: US 2012/0017379 A1
(43) Pub. Date: Jan. 26, 2012

(54) OZONE LAUNDRY SYSTEMS AND RELATED METHODS

(76) Inventors: Mark Edward Moore, Versailles, KY (US); Aaron Cena, Mt. Shasta, CA (US); Jinyang Shi, Shenyang City (CN)

(21) Appl. No.: 13/114,461

(22) Filed: May 24, 2011

Related U.S. Application Data
(60) Provisional application No. 61/367,801, filed on Jul. 26, 2010.

(51) Int. Cl. D06F 37/00; B23P 17/04; D06L 1/20

(52) U.S. Cl. 8/137; 68/5 R; 29/428

(57) ABSTRACT

Ozone laundry systems and related methods are shown and described. In one embodiment, an ozone laundry system includes a washing machine; an ozone generator, a Venturi-injector, a secondary injection device, and an ozone control system (OCS). The washing machine may have a vented drum for holding laundry and a liquid wash bath, and include a plurality of operational configurations. The OCS may be configured to provide ozone to the Venturi-injector when the washing machine is in the fill configuration, and provide ozone to the secondary injection device when the washing machine is in the wash configuration. The result is a system that is able to maintain ozone at a high level for a duration.

### RELATED APPLICATION

This application claims priority to U.S. Patent Application No. 61/367,801 filed 26 Jul. 2010, the entire contents of which are incorporated by reference.

### FIELD OF TECHNOLOGY

The current disclosure relates generally to ozone laundry systems, and more particularly to ozone laundry systems configured to provide improved ozone maintenance throughout a wash cycle.

### BACKGROUND

Washing machines are important for laundering a variety of items, e.g., clothes, towels, linens, etc. Traditional washing machines may use detergent or bleach to launder items. Some have also used ozone as part of the laundering process to facilitate cleaning. For example, ozone laundry systems have been configured as one of three types: Venturi injection systems; bubble diffusion systems; and side arm injection systems. In terms of general construction, Venturi injection systems inject ozonated water into the washing machine on each and every cold or warm fill of the washer. Bubble diffusion systems and side arm injection systems wait until the washer has filled with water, and then inject ozone into the washing machine.

Applicants believe however that existing systems and methods utilizing ozone can suffer from a number of problems, including for example, inconsistent dosing of ozone, inconsistent or insufficient maintenance of ozone in the wash bath, and excessive off gassing of ozone.

In traditional Venturi injections system, for example, the washing machine fills with water containing a relatively high concentration of dissolved ozone. Applicants have observed, however, that over the length of time of a particular step in the wash cycle, the ozone will start to deplete as ozone is consumed by oxidation. Applicants believe this contributes, at least in part, to a depletion in the efficacy of the wash step over time.

In traditional bubble diffusion systems, for example, the washing machine is filled with non-ozonated cold or warm water that is bubbled into the washer through the sump (bottom of the washer drum) of the washing machine. Applicants believe dissolved ozone levels inside the washer will slowly rise and continue to rise until that particular wash cycle is complete, and the water inside the washer is drained. With traditional techniques, ozone levels usually never reach the levels of dissolved ozone that the Venturi Injector system achieves during the fill step of the wash cycle because it is not possible to safely inject similar levels of ozone without releasing potentially unsafe levels of ozone off gas into the ambient space. Applicants believe the potential for unsafe levels of off-gassing may be based on any combination of existing piping system and physical conditions that exist at the point of injection.

It should also be noted that due to usually short duration of each wash step, (usually two to 8 minutes), traditional bubble diffusion systems and traditional side arm injection system are not normally able to reach the same levels of ozone dissolved into the water as traditional Venturi injector systems are. To address this problem, applicants believe that manufacturers of bubble diffuser systems and side arm injection systems typically try to overcompensate by injecting more ozone than can be injected safely. The tendency to inject excessive levels of ozone over powers the injection device/wash bath and only a portion of the ozone is dissolved, creating a major problem of the undissolved ozone gas escaping from the washing machine and entering the laundry room. Ambient ozone in the room can easily reach or exceed the OSHA Federal limits of human exposure, thus creating a hazardous condition to the operators. To address harmful off gassing problems, traditional bubble diffusion systems employ an emergency shut off system designed to turn the ozone generator off when ambient ozone exceeds a predetermined level. Applicants believe however that the reliance on traditional emergency shut off system is not always ideal because, in addition to their additional cost, they often suffer from at least one of intermittent and decreased sensitivity that is typically undetected by the user.

As a result, applicants believe there are various shortcomings in the field.

FIG. 1, for example, illustrates aqueous ozone levels over time as measured with a traditional bubble diffusion system and a traditional Venturi injection system over a variety of wash steps including a flush, a wash, a bleach, a rinse 1, a rinse 2, and a final rinse. As seen, traditional bubble diffusion systems maintain low levels of ozone, e.g., below about 0.2 ppm ozone. In the Venturi injection system, rates are relatively high initially, but quickly drop off to below about 0.2 ppm ozone.

Accordingly, applicants desire, inter alia, systems and methods for the maintenance of higher amounts of ozone. In particular, applicants desire systems and methods for the maintenance of higher amounts of ozone when provisions of ozone are at safe levels. The current disclosure is directed, at least in part, to at least one of the above noted, or additional, problems.

### SUMMARY

The current disclosure is directed to a variety of systems and methods relating to ozone laundering. In one aspect, the disclosure is directed to systems and methods that allow for improved maintenance of ozone.

In one embodiment, an ozone laundry system includes a washing machine, an ozone generator, a Venturi-injector, a secondary injection device, and an ozone control system (OCS). The washing machine may have a vented drum for holding laundry and a liquid wash bath, and include a plurality of operational configurations, such as, a start configuration, a fill configuration, a wash configuration, and a drain configuration. The ozone generator may include at least one ozone cell. The Venturi-injector will typically be plumbed to the ozone generator to provide an ozonated liquid stream to the drum. The secondary injection device, such as a diffuser or side arm injection system, will also be configured to provide ozone to the liquid wash bath. The OCS may be in communication with the ozone generator and the washing machine. Typically the OCS and ozone generator will be arranged to provide ozone to the Venturi-injector when the washing machine is in the fill configuration, and provide ozone to the secondary injection device when the washing machine is in the wash configuration. The result is a system that is able to maintain aqueous ozone concentrations at a high and consistent level, e.g., in a range of about 0.3 ppm to about 2.0 ppm, more typically about in the range of about 0.4 ppm to about 1.3 ppm. Ozone concentrations are determined based on aqueous ozone concentration in a liquid wash bath (H2O) without any laundering items, detergents, or bleaches (an “empty run”). The duration of ozone maintenance may vary, e.g. at least about 3 minutes. In many examples, the duration will be in the range of about 3 to 15 minutes.

The disclosure is also directed to methods of laundering items. In one embodiment, a method includes providing a washing machine; providing an OCS in communication with an ozone generator and the washing machine; providing ozone to a Venturi-injector; and providing ozone to a secondary injection device. Typically, providing ozone to the Venturi-injector will occur when the washing machine is in the fill configuration and providing ozone to the secondary injection device will occur when the washing machine is in the wash configuration. This method allows for, inter alia, the maintenance of aqueous ozone concentrations in a range of about 0.3 ppm to about 2.0 ppm for a duration of at least 3 minutes. In many examples, the duration will be in the range of about 3 minutes to about 15 minutes.

The disclosure is also directed to methods of creating ozone laundry systems. In one embodiment, a method includes obtaining a washing machine, installing a first signal generator, installing a second signal generator, installing a Venturi-injector, installing a secondary injection device, and interfacing an OCS.

Typically, the washing machine will have a vented drum for holding laundry and a liquid wash bath. The operational configurations may vary and may include, for example, at least one of a start configuration, a fill configuration, a wash configuration, and a drain configuration. The Venturi-injector may be plumbed to provide an ozonated liquid stream to the drum. The secondary injection device will be configured to provide ozone to the liquid wash bath. The OCS may be interfaced such that it is in communication with the ozone generator and with the washing machine. The first signal generator will be installed to generate at least a first signal (S1) based on at least one of a sensor and a logic step. The second signal generator will be installed to generate at least a second signal (S2) based on at least one of a sensor and a logic step. The signal generators will typically be interfaced such that the first signal generator generates a first signal (S1) when the washing machine is in the start configuration, the second signal generator generates a second signal (S2) to initiate the fill configuration, and a signal interrupter interrupts S1 when S2 is generated. In operation, the signal interrupter blocks S1 from reaching the OCS in the start configuration, the ozone generator generates ozone and supplies ozone to the Venturi-injector at a first level when the OCS receives the second signal (S2), and the ozone generator generates ozone and supplies ozone to the secondary injection device at a second, lower level when the signal interrupter is turned off.

The results are systems and methods that allow for the unexpected maintenance of higher levels of ozone in the water for long durations, e.g., an entire step of the wash cycle. Systems and methods may include a variety of additional benefits, including at least one of better removal of dirt; improved sanitization and disinfection of items being laundered; potential reduction in water, sewer and chemical usage; safe levels of ambient ozone, etc.

The above summary was intended to summarize certain embodiments of the present disclosure. Systems and methods will be set forth in more detail, along with examples demonstrating efficacy, in the figures and detailed description below. It will be apparent, however, that the detailed description is not intended to limit the present invention, the scope of which should be properly determined by the appended claims.

### BRIEF DESCRIPTION OF THE FIGURES

FIG. 1 is a graph depicting ozone concentrations obtainable with background technologies.

FIG. 2 is a schematic illustrating one example of an ozone system as disclosed herein.

FIG. 3 is a flow chart illustrating one example of a process for controlling the provision of ozone.

FIG. 4 is a graph depicting ozone concentrations obtainable with a system example as disclosed herein.

FIG. 5 is another schematic of an ozone system as disclosed herein.

FIG. 5a is a circuit diagram example.

FIG. 6 is a flow chart illustrating an example of a process for controlling the provision of ozone.

FIG. 7 is another schematic of an ozone system as disclosed herein.

FIG. 8 is another schematic of an ozone system as disclosed herein.

FIG. 9 is another schematic of an ozone system as disclosed herein.

### DETAILED DESCRIPTION OF EXEMPLARY EMBODIMENTS

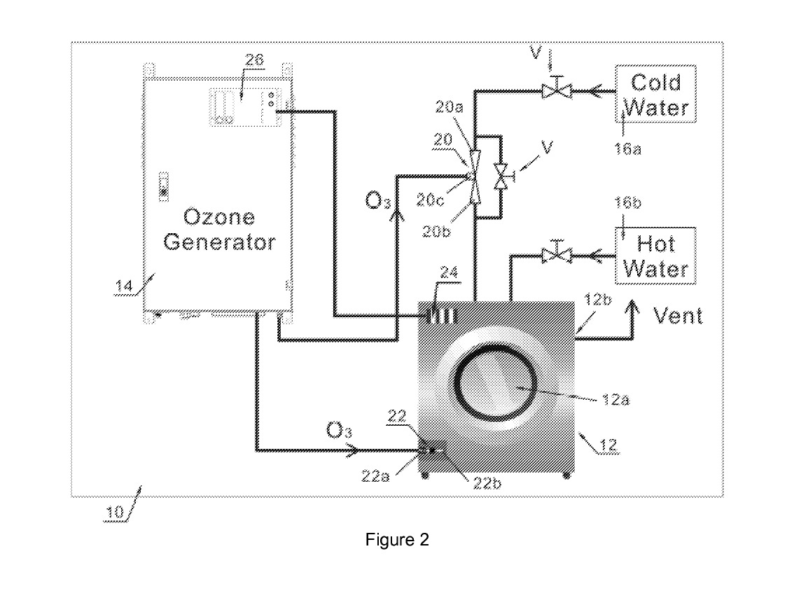

FIG. 2 is a schematic illustrating an ozone laundry system 10, according to one aspect as disclosed herein. System 10 includes washing machine 12 in communication with ozone generator 14.

Washing machines may vary from example to example. Typically, washing machines will include drum 12a for holding laundry and a liquid wash bath. Further, the machine will be configured to receive water from a water source. In this example, the machine is configured to receive water from a cold water source 16a and a hot water source 16b. Water supply from water sources may be controlled by valves V.

Washing machines as described herein may include machines having a vented drum, for example, by including vent 12b. Vented drums, as used herein, includes drums that allow for atmospheric communication between the drum and the ambient atmosphere, such that the buildup of pressure within the drum is reduced or prevented.

Washing machines will also typically have a plurality of operational configurations. For example, configurations may include at least one of a start configuration, a fill configuration, a wash configuration, and a drain configuration. A fill configuration, as used herein, includes configurations that allow wash drums to receive an ozonated liquid stream through a Venturi-injector. A wash configuration, as used herein, includes configurations that allow for agitation or soaking of items being laundered in combination with the provision of ozone from a secondary injection system. A drain configuration, as used herein, includes configurations that allow for ozonated water within the wash drum to be drained and that stops the provision of ozone to the wash drum. A start configuration, as used herein, includes configurations that prepare the ozone generator to begin provision of ozone to the machine.

Systems will typically include at least two, at least three, or at least all of the noted configurations. Further, in some examples, systems will be capable of achieving at least two of the above noted configurations at a time, for example, a fill configuration may overlap with a wash configuration, etc.

Typically, the various configurations will correspond to various steps in the wash cycle. For example, a wash cycle may include a flush step to remove loose dirt; a detergent step to remove remaining dirt; a bleach step to remove stains left by the dirt; a rinse one; a rinse two; a final rinse to add softener; and a neutralizing agent step to counteract any left over bleach. There may also be an extract after the final rinse. Each of these steps may include at least one of a fill configuration, a wash configuration, and a drain configuration, for example. For example, the detergent step may include the start configuration, the fill configuration, the wash configuration, and the drain configuration.

Ozone generators may vary and typically include at least one ozone cell configured to generate ozone after being powered by a power supply. In some examples, a single ozone generator that has the ability for variable ozone output levels may be used. In some examples, a plurality of ozone generators configured to provide a different level of ozone may be used. Further, combinations of the above may be used.

Referring back to FIG. 2, system 10 also includes a Venturi-injector, e.g. injector 20 and a secondary injection device 22, e.g. a diffuser. Venturi-injectors, as used herein, include injectors having a conical body that initiates a pressure difference between inlet and outlet ports of a fluid stream, thereby created a vacuum inside the injector body and pulling ozone into the fluid stream though an ozone suction port. The water inlet port is plumbed to the water source, the ozone suction port is plumbed to the ozone generator, and the outlet port is plumbed to provide an ozonated liquid stream to the drum. In system 10, for example, injector 22 includes inlet port 20a, outlet port 20b, and ozone suction port 20c. Inlet port 20c is plumbed to water source 16a. Ozone suction port 20c is plumbed to ozone generator 14. Outlet port 20b is plumbed to machine 12 where it then provides an ozonated liquid stream to drum 12a. Systems can be configured to allow Venturi-injectors to provide a variety of aqueous ozone concentrations, .e.g. about 0.5 to about 2.5 ppm, more typically about 0.8 to about 2.2 ppm. In many examples, ozone will be provided at about 1.0 ppm to 2.0 ppm.

Secondary injection devices may vary from embodiment to embodiment. In some examples, the secondary injection device will include a diffuser, as noted above. As used herein, a diffuser includes any device capable of creating a plurality of ozone bubbles when ozone is feed to the liquid wash bath. Bubble size may vary. For example, bubbles may have a diameter of about 0.5 mm to about 4 mm. In many examples, bubble size will be about 2 mm. Diffuser 22 includes an ozone inlet port 22a and an ozone outlet port 22. Ozone outlet port 22 is positioned to diffuse ozone into the liquid wash bath positioned within drum 12a. Ozone rates may vary, and will typically be less than that provided by the Venturi-injector. For example, systems can be configured to allow ozone generators to provide ozone gas to the diffuser at a variety of concentrations, .e.g. about 0.05% to about 15% by weight of gas delivered to the diffuser. More typically, systems will be configured to provide ozone gas in the range of about 0.25% to about 5% by weight of gas.

Secondary injection devices may also include side arm injection systems. As used herein, a side arm injection system includes a Venturi-injector and a system for cycling water from the washtub, through the Venturi-injector, and back into the washtub. For example, a side arm injection system may draw water out from the bottom of the washer and pipe it through a pump and a Venturi-injector where ozone is injected into the water before being fed back into the washer drum. Side arm injection systems may also include a filter to prevent lint from the linen from clogging the Venturi injector. In many examples, side arm injection systems will also include an air trap positioned in between the Venturi-injector and the washing machine, for example, to capture un-dissolved ozone. Recirculation may continue through the duration of the particular wash step. Ozone rates for side arm injection systems may vary, and will typically be less than that provided by the Venturi-injector. For example, systems can be configured to allow side arm injection systems to provide a variety of ozone concentrations, .e.g. about 0.1 to about 1.5 ppm, more typically about 0.4 to about 1.3 ppm.

In many examples, depending on source water chemistry for example, applicants may adjust the ozone delivered to the Venturi-injector or secondary injection device to achieve the desired aqueous ozone concentration delivered in a safe manner. Table 1 illustrates adjustment examples based on prophetic water sources having a water quality X and a water quality Y. Water qualities may correspond to any combination of pH and organic load, for example. In Example 1, it is desired to have an aqueous ozone concentration in the wash bath of 1.3 ppm at 3 minutes. In Example 2, it is desired to have an aqueous ozone concentration in the wash bath of 1.2 ppm at 5 minutes. In both examples, unsafe ozone off gassing is also monitored.

TABLE 1

| | Example 1 | | | |
|---|---|---|---|---|
| | Trial | | Example 2 | |
| | Run 1 | Adjusted Run 1 | Trial Run 2 | Adjusted Run 2 |
| | (Min 3) | (Min 3) | (Min 5) | (Min 5) |
| Venturi- | 1.7 ppm | 1.7 ppm | 1.8 ppm | 1.5 ppm |
| Injector | | | | |
| Secondary | 1% wt of | 2.7% wt of gas | 7% wt of gas | 2.7% wt of gas |
| Device | gas | | | |
| Water | X | X | Y | Y |
| Quality | | | | |
| Desired | 1.3 ppm | 1.3 ppm | 1.2 ppm | 1.2 ppm |
| [Aqueous] | | | | |
| Measured | 0.5 ppm | 1.3 ppm | 1.6 ppm | 1.2 ppm |
| [Aqueous] | | | | |
| Off Gas | OK | OK | Unacceptable | OK |
| Levels | | | | |

As seen, adjustment of ozone can be used provide a desired aqueous concentration at a duration. It should be clear, that in other examples, other aqueous ozone concentrations may be desired for a particular duration. For example, a measured aqueous concentration of any of 0.4 ppm, 0.5 ppm, 0.6 ppm, 0.7 ppm, 0.8 ppm, 0.9 ppm, 1.0 ppm, and 1.1 ppm at any of at least 2 minutes, at least 3 minutes, at least 4 minutes, at least 5 minutes, at least 6 minutes, at least 7 minutes, at least 8 minutes, or longer, with safe off gas levels, may be very desirable, particularly relative to traditional techniques. In one example, applicants' discovery allows for the maintenance of an ozone concentration in the range of 0.3 to 2.0 ppm for a duration in the range of 3 to 15 minutes. In another example, applicants' discovery allows for the maintenance of an ozone concentration in the range of 0.4 to 1.3 ppm in a range of 4 to 15 minutes.

Safe off gas levels may vary from example to example. In many examples, applicants consider levels below at least one 0.2 ppm, 0.1 ppm, 0.09 ppm, 0.08 ppm, 0.07 ppm, 0.08 ppm, 0.05 ppm, 0.04 ppm, 0.03 ppm, 0.02 ppm and 0.01 ppm to include safe off gas levels. Off gas measurements are based on parts of gas per million parts of contaminated air by volume at 25 degrees C. and 760 torr Safe levels are determined based on readings from breathing-zone air samples with an 8 hour time weighted average.

Systems will also often include an ozone control system (OCS), e.g. OCS 26, for controlling the supply of ozone to the Venturi-injector or secondary injection device. A variety of OCS configurations may be used, but in many examples, an OCS will include a signal receiver and be in communication with the ozone generator and the washing machine. Additionally, the OCS will be configured to control the provision of ozone to the Venturi-injector when the washing machine is in the fill configuration, and control the provision of ozone to the secondary injection device when the washing machine is in the wash configuration.

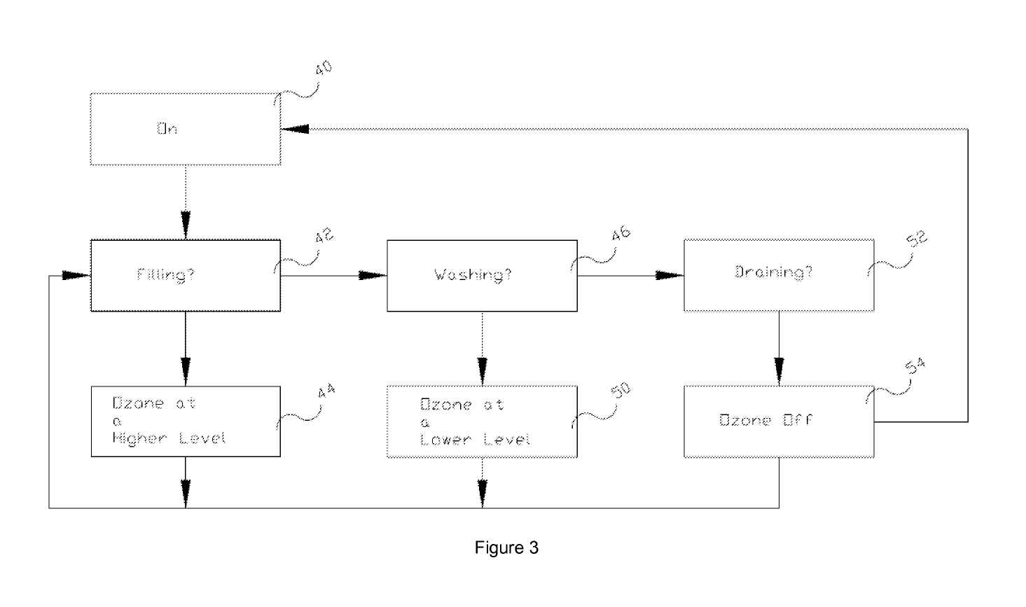

FIG. 3 illustrates one example of flow process for controlling the provision of ozone in a system as disclosed herein, e.g., system 10. In step 40, the system is turned on, e.g. an ozone generator is activated. In step 42, a sensor or logic determines if water from a water source is filling the drum. If yes, in step 44, the OCS is configured to instruct the ozone generator to provide ozone at a higher level to the Venturi-injector. In this example, the OCS is configured to continue instructing for ozone at a higher level until a predetermined amount of filling has been achieved, e.g., the wash drum is filled to its desired capacity. In step 46, once the system is no longer in its filling configuration, the OCS instructs to provide ozone at a lower level to the secondary injection device (e.g. the diffuser or the side-arm injector) as illustrated in step 50. Step 50 may be considered a wash configuration. In step 52, the system initiates draining the wash drum, which results in the OCS turning off the ozone to the washing machine. Systems may repeat steps 42, 44, 46, 50, 52 and 54 a number of times as dictated by the particular wash sequence. Once the wash cycle is complete, ozone provision can be initiated again by step 40.

Many embodiments will additionally include at least one signal generator, e.g., signal generator 24 in communication with an ozone control system (OCS) 26. Signal generator 24 generates at least one signal S depending on, for example, a sensor or logic step. Signal generators may include integration with, or piggy-backing on, existing machine signal generation systems. Signal generators may also be components of discrete signaling systems. OCS 26 includes a signal receiver for receiving signal S and controls the provision of ozone to the machine. Configurations of the OCS and signal generators may vary.

Applicants have discovered that systems and methods disclosed herein allow for the provision or maintenance of ozone at high and consistent levels that are completely unexpected based on the performance of traditional systems. For example, applicants systems and methods are able to safely maintain aqueous ozone concentration in a range of about 0.1 ppm to about 3.0 ppm, more typically about 0.3 ppm to about 2.0 ppm, and even more typically about 0.4 ppm to about 1.3 ppm in the liquid wash bath for duration. Durations may vary. For example, applicants' inventions allow for the maintenance of ozone levels for a duration chosen from at least one of: at least 1 minute; at least 2 minutes; at least 3 minutes; at least 4 minutes; at least 5 minutes, at least 6 minutes, at least 7 minutes, at least 8 minutes, at least 9 minutes, and at least 10 minutes. In most examples, the system is able to maintain ozone levels for a duration chosen from at least one of 4 to 15 minutes. As used herein, duration of ozone maintenance is determined based on aqueous ozone concentration in a liquid wash bath (H2O) without any laundering items, detergents, or bleaches (an “empty run”).

Concentration of aqueous ozone can be determined using the decolorization reaction of indigo trisulfate with ozone as compared to a negative control, which is known in the art. Briefly, ozone concentration is proportional to the loss of color and can be measured using a photospectrometer (λ=600 nm). Ozone concentration may also be determined using an ORP (oxidation reduction potential) meter.

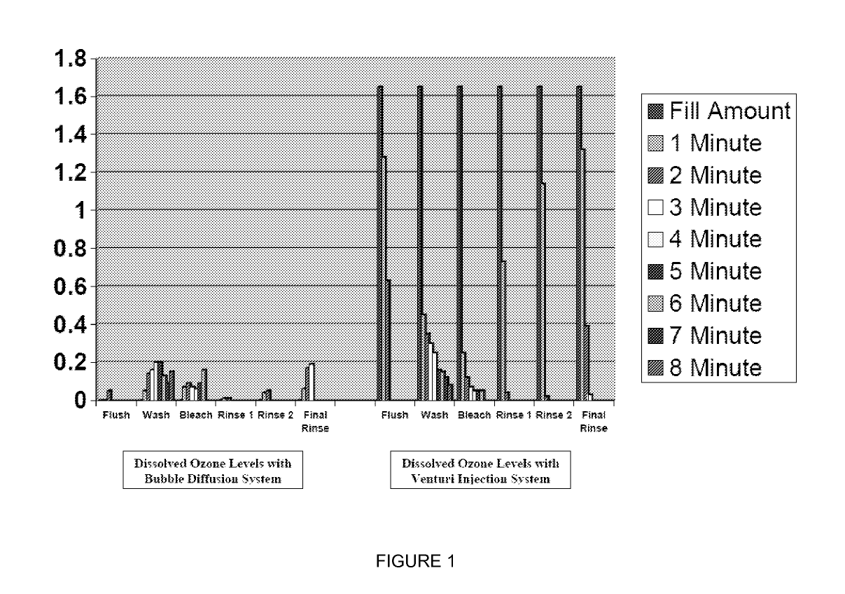

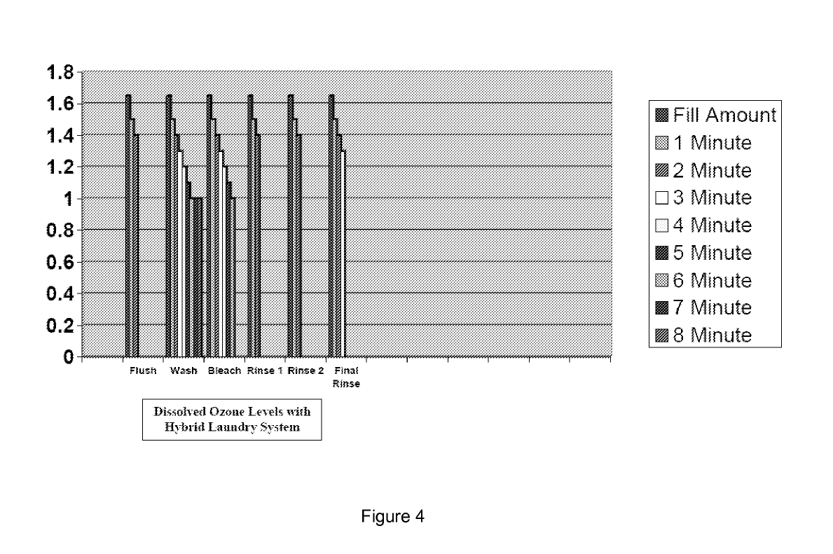

FIG. 4 illustrates dissolved ozone levels obtained according to an example of the disclosure. A plurality of steps in the wash sequence are illustrated, including a Flush, Wash, Bleach, Rinse 1, Rinse 2, and Final Rinse. For each step, the Fill Amount bar corresponds to the fill configuration, and the subsequent bars related to duration corresponding to the wash configuration. For example, the Bleach Step includes a fill configuration and a wash configuration, with ozone concentration in the wash configuration illustrated over 6 one-minute-interval readings. As illustrated, ozone levels are maintained at significantly higher levels than those illustrated in FIG. 1, even though provision of ozone is the same. Ozone was provided using an ARTICLEAN ozone generator (PB-10) set to provide 5% ozone, by weight of gas.

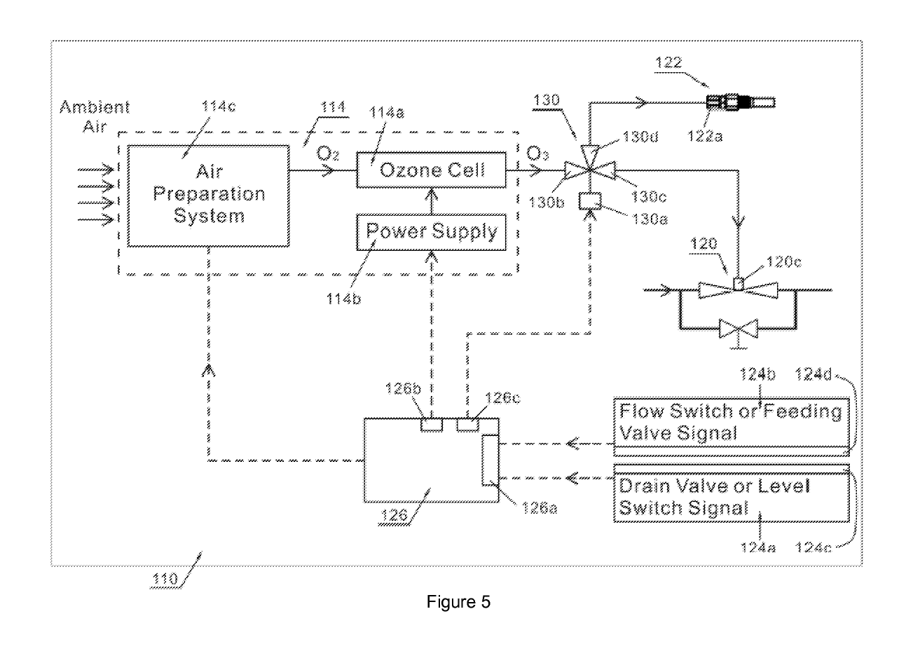

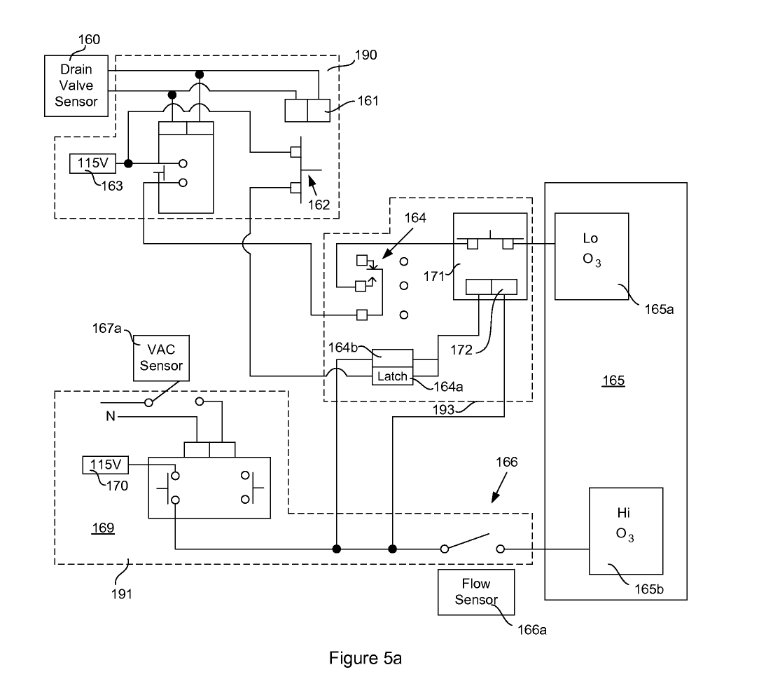

FIG. 5 illustrates system 110, which is somewhat similar to system 10 described above. System 110 includes another example of an OCS, OCS 126, in communication with ozone generator 114 and signal box 124 of a washing machine (not illustrated). OCS 126 includes signal receiver 126a for receiving signals from signal box 124. OCS 126 may include a signal generator 126b for sending signals to ozone generator 114. Box 126b may also be considered a contact for establishing communication with ozone generator 114. In this illustration, ozone generator 114 includes ozone cell 114a, a component for supplying power to the ozone cell, referred to as power supply 114b, and air preparation system 114c for providing O₂ to ozone cell 114a, any of these components may be discrete or integral in various examples encompassed within the disclosure. The signal box is illustrated as including a plurality of signal generators, e.g. first signal generator 124a and a second signal generator 124b. Systems may also include a third signal generator 124c and signal interrupter 124d. Signal boxes may be conceptual, e.g., to illustrate various signal generators that are located at various places on the washing machine, for example, or represent a physical location for locating signal generators, or some combination thereof.

First signal generator 124a is configured to generate a first signal (S1) to initiate the start configuration. Systems may be configured in a variety of ways. For example, the first signal generator may include a relay, e.g. an electrical or mechanical switch, in communication with a power supply. Typically, the relay will be configured to turn on or off based on at least one of a sensor and a logic step. If the first signal generator is in communication with a sensor, the sensor may include or be configured to detect the operation of any of a power switch, a start switch, a closed drain valve, or operation of another structure related to a start configuration. If the first signal generator is in communication with a logic step, the logic step may be any step related to initiating or establishing a start configuration. Further, the logic step may be any step related to the operation of any of a power switch, a start switch, closing a drain valve, or another structure that relates to or indicates a start configuration. In various examples, therefor, either a sensor, a logic step, or both may actuate the first signal generator to produce S1.

Second signal generator 124b is configured to generate a second signal (S2) to initiate the fill configuration. For example, the second signal generator may include a relay, similar to as described above. The relay may be configured to turn on or off based on at least one of a sensor and a logic step. If the second signal generator is in communication with a sensor, the sensor may include or be configured to detect the operation of any of a feeding valve, a flow switch, a pressure switch configured to detect vacuum created by the Venturi-injector, or another structure related to or that senses fill water flowing to the drum. If the second signal generator is in communication with a logic step, the logic step may be any step related to a fill configuration, e.g. actuation of a filling flow valve, etc. In various examples, therefor, either a sensor, a logic step, or both may actuate the second signal generator to produce S2. The second signal generator may continue to provide S2 while the washing machine is in the fill configuration.

Signal interrupter 124d is configured to interrupt S1 when S2 is generated and allows S1 to reach the OCS when turned off, for example by the opening of the second signal generator. In one example, the signal interrupter includes a relay, e.g. a latch relay, configured to actuate based on at least one of a sensor, a logic step, S1, and S2. If the signal interrupter is in communication with a sensor, the sensor may sense operation of a feeding valve, a flow switch, or another structure that detects the absence of a filling flow to the drum. The sensor may similarly sense the operation of an agitator, a drum rotator, or similar structure. If the signal interrupter is in communication with a logic step, the logic step may be any step related to closing a feeding valve, operating an agitator, a drum rotator, etc. In various examples, therefor, any of a sensor, a logic S1 and S2 may actuate the signal interrupter.

Ozone generator 114 and OCS 126 are arranged such first signal generator 124a generates a first signal in the start configuration. Signal interrupter 124d, however, blocks S1 from reaching OCS 126 in the start configuration. Ozone generator 114 generates ozone and supplies ozone to the Venturi-injector at a first level when the OCS receives the second signal (S2), and the ozone generator generates ozone and supplies ozone to the secondary injection device at a second, lower level when the signal interrupter is turned off, e.g., by flow switch 124b no longer detecting flow.

Ozone control systems may operate in a variety of ways. In one example, two separate ozone generators may be used each having a corresponding OCS signal receiver. For example, signal receiver for receiving S1 for low level ozone generation, the other capable of receiving S2 for high level ozone generation, wherein the generators may make ozone or not based on the signal received. In another example, a single ozone generator with two separate ozone “cells” or “ozone generation modules” may be used. One cell or module would be used to generate low levels of ozone, the other cell or module would be used to generate high levels. The “cell” or “ozone generation module” that will be on at any given time is determined by the signal received, e.g S1 or S2, from the washing machine. In another example, a single ozone generator with a single “cell” or “ozone generation module”, but with variable ozone output capabilities may be used. A generators ozone output may be changed, for example, by varying the input voltage to a high-voltage transformer, where higher voltage increases ozone output; by varying the output frequency of the high-voltage transformer; or by varying the duty cycle, where output frequency of the high-voltage transformer remains constant, but is turned “on” for periods of time, with period of time in between where it is turned “off”. An input signal (e.g. 0-20 mA, 4-20 mA, 0-5 Vdc, 0-10 Vdc, 0-15 Vdc) may be input to the ozone generator based on the signal that is received from the washing machine. Based on the value of the input signal, a proportional ozone output will be generated. For example, during low level ozone generation, the ozone generator may receive an input signal of 4 Vdc, and during high level ozone generation and input signal of 10 Vdc. (or, 2 mA during low level and 19 mA during high level, etc.). In another example, a control loop (e.g a 4-20 mA, 0-10 Vdc, etc loop) having adjustable resistance may be used, where the signal from the signal generator controls resistance to control output.

OCS 126 may also include a valve-actuation signal generator for actuating any number of valves plumbed between the ozone generator and the washing machine. For example, OCS 126 includes valve-actuation signal generator 126c configured send a valve actuation signal (VAS) to actuator 130a configured to actuate valve 130. In this example, valve 130 is a 3-way valve having input 130b, first output 130c, and second output 130d. Output 130c is plumbed to the ozone suction port 120c of Venturi-injector 120. Output 130d is plumbed to ozone inlet port 122a of diffuser 122. Actuator 130a and valve 130 may be configured such that the energizing actuator 130a directs ozone to 130d or 130c upon receipt of the VAS.

In this example, OCS 126 is illustrated as a discrete component, but in some examples, the OCS may be integrated, at least in part, with the ozone generator. In examples where the OCS is at least partially integrated with the ozone generator, the OCS is still considered to be in communication with the ozone generator. Further, air preparation systems may similarly be integrated or discrete components, and systems as disclosed herein can be configured to service a plurality of washing machines. FIG. 5a illustrates a circuit diagram example of the interface between a plurality of sensors (160, 166a, and 167a), first signal generator 190, second signal generator 191, signal interrupter 193 and OCS receiver 165. In this example, a sensor 160 detects a closed drain valve on a washing machine, which causes relay coil 161 to close relay 162 of the first signal generator. The closed relay 162 energizes relay coil 164a of signal interrupter 164, e.g. a latching relay, to open signal interrupter 164. The closed drain valve also sends a first signal S1 from power supply 163 to signal interrupter 164. The open latching of signal interrupter 164, however, prevents S1 from reaching OCS signal receiver 165a and providing ozone via the secondary injection device to an empty wash drum.

Upon filling of the drum, a sensor, e.g. flow sensor 166a, detects flow to the wash drum and activates second signal generator, e.g. switch 166, which allows a second signal S2 to be provided from power supply 170 to OCS receiver 165b for the production of ozone at the higher level. Sensor 166a may similarly be a flow valve sensor, etc. as previously described. In this example, S2 is also under the control of a vacuum sensor 167a, which detects vacuum created by water flow through the Venturi injector. The detection of vacuum by sensor 167a will close switch 167, causing relay coil 168 to close relay 169 and provide S2.

The closing of switch 167 will also energize relay coil 164b of the signal interrupter 164, which turns off or closes signal interrupter 164 and allow S1 to reach normally closed relay 171 (“NC relay”). To avoid conflicting commands, switch 167 also energizes relay coil 172 of NC relay 171, thereby preventing S1 from reaching the OCS receiver 165a.

Once the wash drum has filled to the desired amount, e.g. flow is no longer detected by sensor 166a, switch 166 is opened, which de-energizes NC relay 171 and allows S1 to reach OCS receiver 165a for the production of low levels of ozone.

When the drain valve opens, the ozone generator is signaled to cease ozone production. The signal interrupter may also be turned on. A variety of similar configurations are apparent based on the teachings contained herein.

Still, in other examples, the signal interrupter may include a time delay device. For example, when the drain valve closes, S1 is delayed for a preset period of time. The time is determined based upon length of time needed to fill the washing machine to capacity. When the fill valve opens, as previously described for example, S2 is generated and a high level of ozone is generated and injected via the Venturi-injector. When the fill is complete, high level ozone turns off. By this time, the time delay has run out, which allows the signal to generate low level ozone to get through and low level ozone to be generated. When the drain valve opens, the time delay device goes into standby waiting for the signal to reset itself and begin the time countdown again (this signal may include the closing of the drain valve).

Systems may also contain a third signal generator, e.g. third signal generator 124c, which is configured to generate a third signal (S3) to initiate the drain configuration. For example, the third signal generator may include a relay configured to turn on or off based on at least one of a sensor and a logic step. If the third signal generator is in communication with a sensor, the sensor may include or be configured to detect the operation of any of a drain valve, a flow sensor positioned downstream from the drain valve, or another structure that senses a drain configuration or the end of a wash configuration. If the third signal generator is in communication with a logic step, the logic step may be any step related to a drain configuration. In operation, therefor, either a sensor, a logic step, or both may actuate the third signal generator to produce S3. OCS and ozone generators may, accordingly, be arranged such that the supply of ozone is turned off when the OCS receives the third signal (S3). Some systems may also include an emergency shut off switch, for example, a vacuum switch that shuts off the ozone generator in the event another switch malfunctions.

The current disclosure is also directed to methods of making ozone laundry systems, e.g., any of those disclosed herein or additional systems. Methods may include obtaining a washing machine, e.g., manufacturing a new machine or procuring an existing machine. Washing machines may vary, as noted, but will typically include a vented drum for holding laundry and a liquid wash bath.

Methods may also include creating a plurality of operation configurations, e.g. at least one of a start configuration, a fill configuration, a wash configuration, and a drain configuration.

Methods will typically include installing at least one signal generator. For example, a first signal generator configured to generate a first signal (S1) to initiate the start configuration may be installed. The first signal generator may be similar to any of the first signal generators previously described. Installation of the first signal generator may vary. Methods may also include installing a second signal generator configured to generate a second signal (S2) to initiate the fill configuration. The second signal generator may be similar to any of the second signal generators previously described. Installation of the second signal generator may vary. Methods may also include installing at least one of a signal interrupter and a third signal generator.

Methods may also include providing an ozone generator. The ozone generator may be similar to any of those previously described. For example, the ozone generator may include at least one ozone cell and at least one power supply in communication with the at least one ozone cell.

Methods may also include installing a Venturi-injector having an ozone suction port, a water inlet port, and an outlet port. Installing the Venturi-injector will typically include at least one of plumbing the water inlet port to the water source, plumbing the ozone suction to the ozone generator, and plumbing the outlet port to provide an ozonated liquid stream to the drum. More typically, installing will include at least two, or at least three of the noted steps. Methods may also include installing a secondary injection device configured to provide ozone to the liquid wash bath. The secondary injection device may vary as noted, e.g., including at least one of a diffuser and a side-arm injector. If installing a secondary injection device includes installing a diffuser, installation will typically include positioning the diffuser to diffuse ozone into the liquid wash bath positioned within the drum. The opposite end of the diffuser will typically be plumbed to an ozone generator. If installing a secondary injection device includes installing a side-arm injector, installation will typically include plumbing the water inlet port of a Venturi-injector to the liquid wash bath, plumbing the ozone suction port of the Venturi-injector to the ozone generator, and plumbing the outlet port to provide an ozonated liquid stream to back to the liquid wash bath. It may be necessary to install a pump to further facilitate fluid transfer through the side-arm system. Some examples may also include the installation of an air trap to capture ozone not dissolved in the water.

Methods of installing may also include interfacing an ozone control system (OCS) with the washing machine and the ozone generator. As described, an OCS may include, for example, at least one signal receiver configured to receive S1 and S2, and may be interfaced with the ozone generator to provide variable levels of ozone, or be interfaced to different ozone generators, each for providing different amounts of ozone, or some combination thereof. Methods of installing may also include installing valves and additional signal generators to actuate valves, as discussed, for example.

Methods disclosed herein are also directed to methods of laundering items. In one embodiment, a method comprises providing a washing machine. The washing machine may have a vented drum for holding laundry and a liquid wash bath, and a plurality of operational configurations, including, for example, any of those described above. The method may also include providing an OCS in communication with an ozone generator and the washing machine. The method may also include providing ozone to a Venturi-injector when the washing machine is in the fill configuration and providing ozone to a secondary injection device when the washing machine is in the wash configuration. Ozone may be maintained at a level in a range of about 0.3 ppm to about 2.0 ppm for a duration chosen from at least one of: at least 2 minutes, at least 3 minutes, at least 4 minutes, at least 5 minutes, at least 6 minutes, at least 7 minutes, and at least 8 minutes. More typically, ozone will be maintained in a range of about 0.4 ppm to 1.3 ppm for a duration in the range of 4 to 15 minutes.

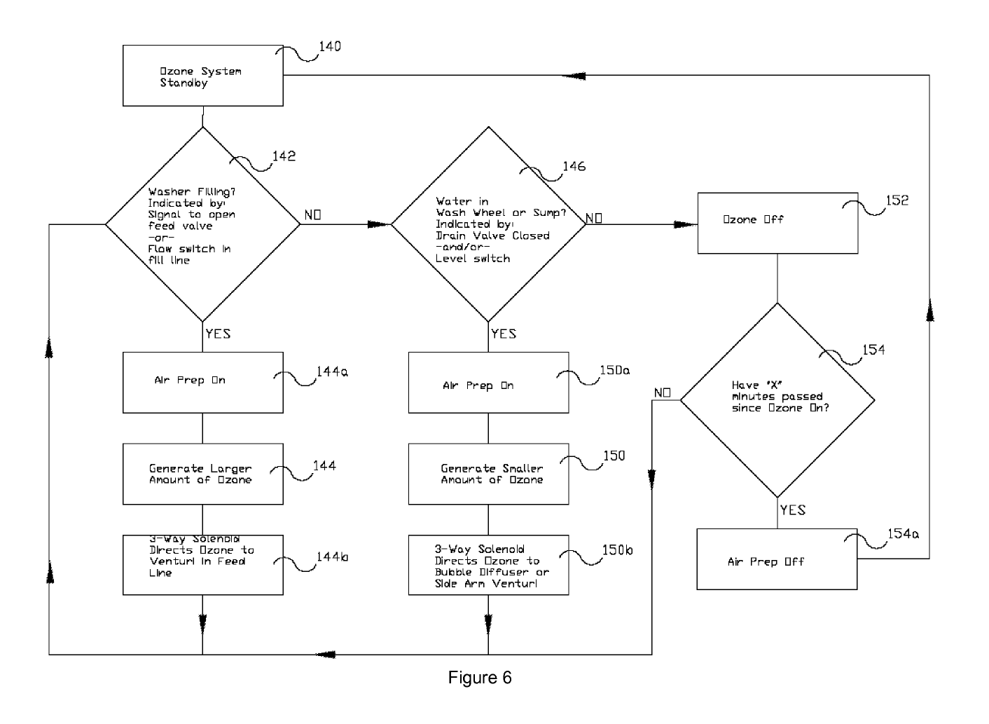

FIG. 6 illustrates another example of a flow process for operating a system as disclosed herein, e.g., system 110. In step 140, the ozone system is in the start configuration, achieved for example, by the closing of a drain on the wash drum, causing a first signal generator to generate a first signal (S1).

In step 142, a sensor determines if the washing machine is filling. The sensor may be configured to detect at least one of the opening of a feed valve, a flow switch in a feed line, and a pressure switch configured to detect vacuum created by the Venturi-injector. If filling is detected, a second signal generator generates S2. In step 144, S2 reaches the signal receiver of the OCS, causing the ozone generator to provide ozone at a level to the Venturi-injector, thereby establishing the fill configuration. Operations may additionally include step 144a, illustrating the activation of the air preparation system and/or step 144b, illustrating the activation of a 3-way solenoid valve to direct ozone to the ozone suction port. Step 144b may be initiated for example, by S1, S2, or the presence or absence of a valve actuation signal (VAS), which may energize or de-energize the valve. In this example, the system is configured to continue providing ozone at a higher level to the Venturi-Injector until a predetermined amount of filling has been achieved, e.g., the wash drum is filled to its desired capacity.

In step 146, a sensor detects a predetermined amount of water in the drum to initiate the wash configuration. The wash configuration may be initiated, for example, by at least one of a level switch reading, a closed fill valve, absence of a fill flow, etc., thereby cancelling S2 and turning off the signal interrupter to allow S1 to reach the OCS. In the wash configuration, the system provides ozone at a lower level to the secondary injection device (e.g. the diffuser or the side-arm injector) as illustrated in step 150. Operations may additionally include step 150a, illustrating the activation of the air preparation system. Step 150a may be initiated, for example, by S1, S2, or another signal. Operations may additionally include step 150b, illustrating the activation of a 3-way solenoid valve to direct ozone to the secondary injection device. Step 150b may be initiated for example, by S1, 52, or the presence or absence of a valve actuation signal (VAS), which may energize or de-energize the valve.

If in step 146, a sensor determines that the washing machine is draining, in step 152, the system initiates the drain configuration and turns off ozone to the washing machine. Turning off may be achieved by turning off the first signal generator, stopping the production of ozone, e.g. by the interruption of a signal to the OCS or ozone generator, or by interrupting the flow of ozone to the washing machine. In step 154 logic, e.g. at the OCS, determines if a predetermined number of minutes have passed since the ozone was on. Minutes may vary based on wash cycle, washer volume etc. If yes, then in step 154a, the air prep to the ozone is turned off. Systems may repeat steps any number of times during a wash cycle.

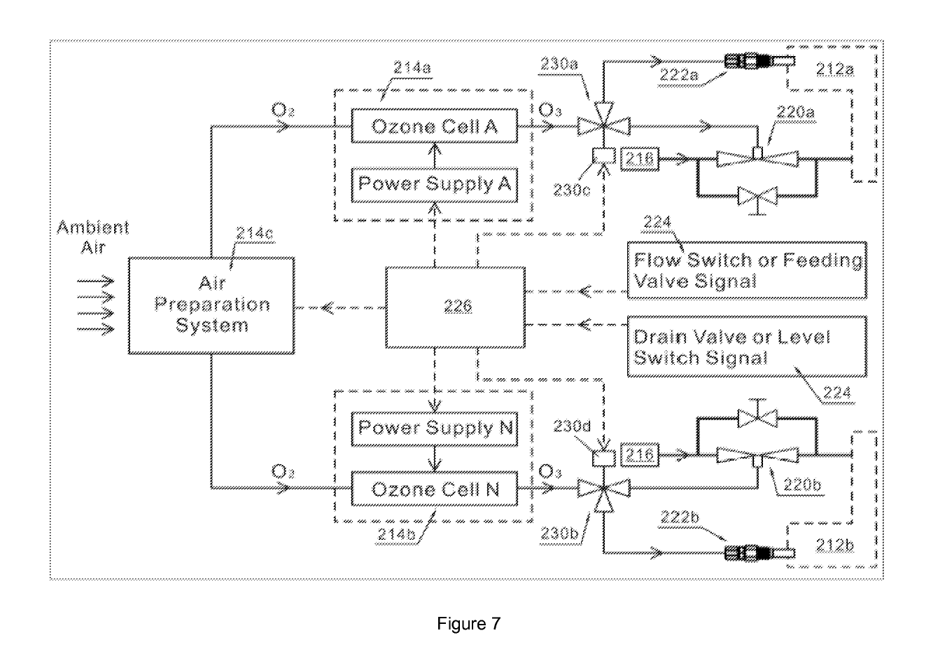

FIG. 7 illustrates system 200, which is another example of a system disclosed herein. System 200 includes OCS 226 in communication with a pair of ozone generators 214a and 214b. OCS 226 is also in communication with signal box 224 of at least one washing machine. In this example, a pair of washing machines 212a and 212b are illustrated. Machine 212a is fed by Venturi-injector 220a and secondary injection device 222a, which is a diffuser in this example. As previously described, the Venturi-injector includes a water inlet port plumbed to water source 216, an ozone suction port plumbed to the ozone generator, and an outlet port plumbed to provide an ozonated liquid stream to the drum of machine 212a. Secondary injection device 222a, illustrated as a diffuser in this example, is plumbed to create a plurality of bubbles in a liquid wash bath contained in the drum of machine 212a. In other examples, secondary injector 222a may represent a side-arm injector. Machine 212b is fed by Venturi-injector 220b and secondary injection device 222b, which is a diffuser in this example. Venturi-injector 222b is similarly plumbed to water source 216 and configured to provide an ozonated liquid stream to the drum of machine 212b. Secondary injection device 222b, illustrated as a diffuser in this example, is plumbed to create a plurality of bubbles in a liquid wash bath contained in the drum of machine 212b. In other examples, secondary injector 222b may represent a side-arm injector.

Signal box 224 can be considered to be in communication with each of washing machines 212a and 212b and additional machines, and may be considered to be representative of a plurality of signal boxes, each being in communication with at least one of a plurality of machines.

OCS 226 may include at least one signal receiver as described previously, e.g. 126a, for receiving signals from signal box 224. OCS 226 may also include also a contact for sending signals to either ozone generator 214a and 214b. In this illustration, ozone generator 214a includes ozone cell A and power supply A. Ozone generator 214b includes ozone supply N and power supply N. An air preparation system 214c provides O₂ to at least one of ozone generator 214a and 214b. Signal box 224 may be considered to include a plurality of signal generators, e.g. at least one first signal generator, at least one second signal generator, and at least one signal interrupter. In examples including a fewer number of signal boxes than machines, the number of generators of a particular type may correspond to the number of washing machines for example, e.g., if three machines are present, signal box 224 may include 3 first signal generators, etc. Signal generators and interrupters may be similar to those previously described.

Ozone generators 214a and OCS 226 are arranged such that ozone generator 214a generates ozone and supplies ozone to Venturi-injector 220a at a first level when the OCS receives the second signal (S2); supplies ozone to diffuser 222a at a second, lower level when the OCS receives the first signal (S1), and turns off the supply of ozone when the OCS no longer receives S1. Ozone generators 214b and OCS 226 are arranged such that ozone generator 214b generates ozone and supplies ozone to Venturi-injector 220b at a first level when the OCS receives the second signal (S2); supplies ozone to diffuser 222b at a second, lower level when the OCS receives the first signal (S1), and turns off the supply of ozone when the OCS no longer receives S1.

Systems may also include at least one valve-actuation signal generator for actuating valve 230a, 230b, or additional valves plumbed between the ozone generator and the washing machine. For example, OCS 226 may include at least one valve-actuation signal generator configured to send a valve actuation signal (VAS) to actuator 230c or 230d, which are configured to actuate valves 230a and 230b respectively. Valves 230a and 230b are 3-way valves having inputs, and first and second outputs similar to previously described.

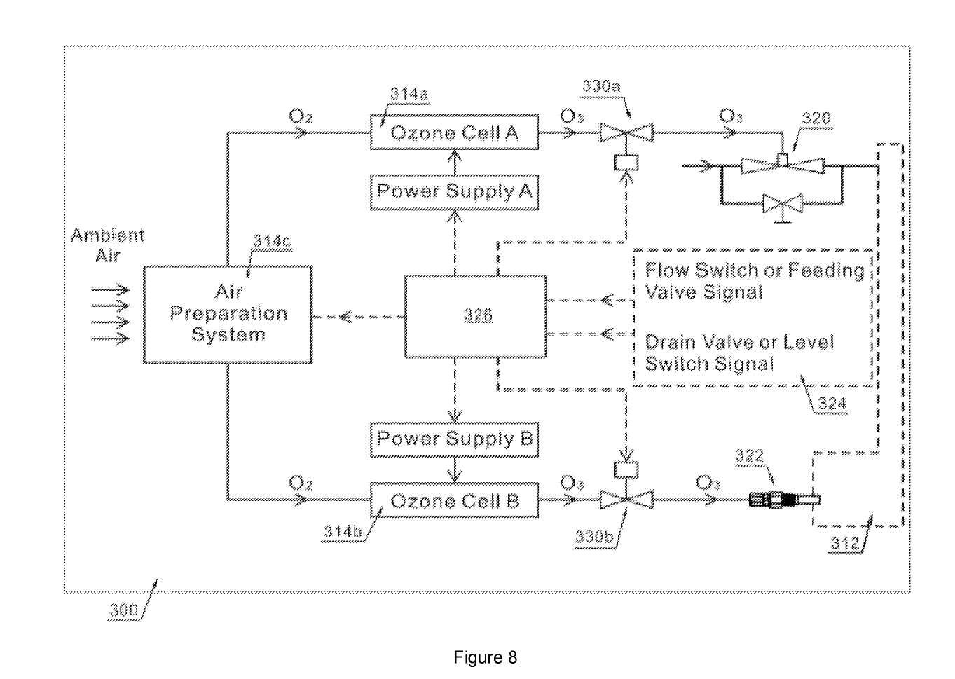

FIG. 8 illustrates system 300, which is another example of a system disclosed herein, which uses more than one ozone generator to feed a single washing machine. In this example, washing machine 312 is fed by Venturi-injector 320 in communication with ozone generator 314a. Secondary injection device 322 is in communication with ozone generator 314b. Operation is somewhat similar to previously described, with signal box 324 in communication with OCS 326.

OCS 326 may include at least one signal receiver as described previously, e.g. 126a, for receiving signals from signal box 324. OCS 326 may also include a signal generator, e.g. similar to signal generators previously described, for sending signals to either ozone generator 314a or 314b. Ozone generators 314a and 314b and OCS 326 are arranged such that ozone generator 314a generates ozone and supplies ozone to Venturi-injector 320 at a first level when the OCS receives the second signal (S2). Ozone generator 314b supplies ozone to diffuser 322 at a second, lower level during the wash configuration, e.g. when the OCS receives the S1. OCS 326 may also include a signal generator or contact, e.g. similar to those previously described, for sending signals to either ozone generator 314a or 314b, for example for modulation or the selection of variable resistance in a control loop.

OCS 326 may also include at least one valve-actuation signal generator for actuating valve 330a, 330b, or additional valves plumbed between the ozone generator and the washing machine. For example, OCS 326 may include at least one valve-actuation signal generator configured to send a valve actuation signal (VAS) to actuator 330c or 330d, which are configured to actuate valves 330a and 330b respectively. Valves 330a and 330b are 2-way valves having an input and an output, however, other types of valves may be used.

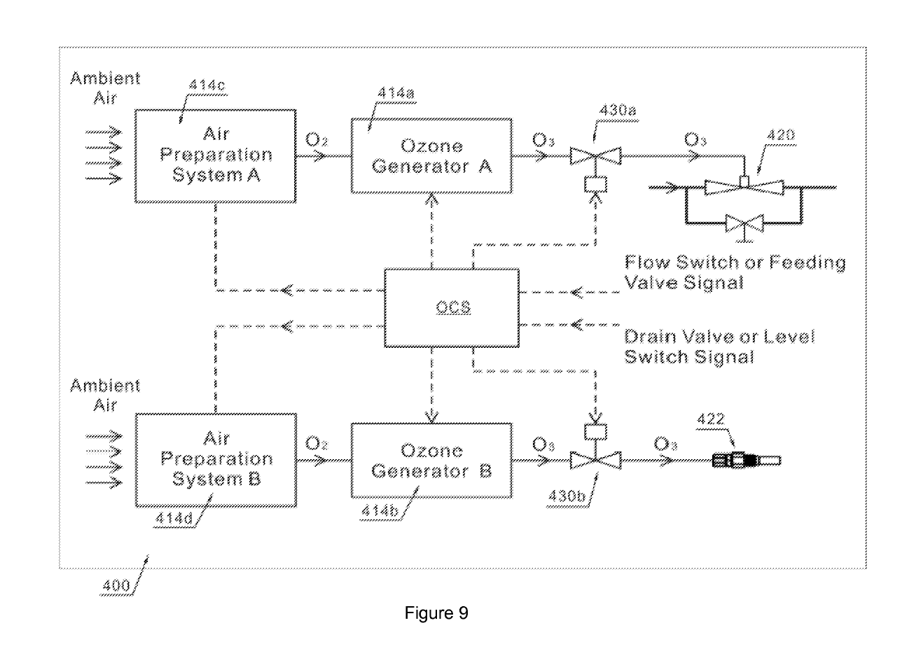

FIG. 9 illustrates system 400, which is another example of a system disclosed herein, which is generally similar to system 300, but includes more than one air preparation system. As seen in this example, air preparation system 414c feeds ozone generator 414a, and air preparation system 414d feeds ozone generator 414b. Valves 430a and 430b, Venturi injector 420, and secondary injection device 428 are generally similar to previously described components.

Numerous characteristics and advantages have been set forth in the foregoing description, together with details of structure and function. The disclosure, however, is illustrative only, and changes may be made in detail, especially in matters of shape, size, and arrangement of parts, within the principle of the invention, to the full extent indicated by the broad general meaning of the terms in which the general claims are expressed.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all subranges subsumed therein, and every number between the end points. For example, a stated range of “1 to 10” should be considered to include any and all subranges between (and inclusive of) the minimum value of 1 and the maximum value of 10; that is, all subranges beginning with a minimum value of 1 or more, e.g. 1 to 6.1, and ending with a maximum value of 10 or less, e.g., 5.5 to 10, as well as all ranges beginning and ending within the end points, e.g. 2 to 9, 3 to 8, 3 to 9, 4 to 7, and finally to each number 1, 2, 3, 4, 5, 6, 7, 8, 9 and 10 contained within the range. Additionally, any reference referred to as being “incorporated herein” is to be understood as being incorporated in its entirety.

It is further noted that, as used in this specification, the singular forms “a,” “an,” and “the” include plural referents unless expressly and unequivocally limited to one referent.

What is claimed is:

1. An ozone laundry system configured to receive water from a water source, the system comprising:
(a) a washing machine having
a vented drum for holding laundry and a liquid wash bath, and
a plurality of operational configurations including a start configuration, a fill configuration, a wash configuration, and a drain configuration;
(b) an ozone generator including at least one ozone cell;
(c) a Venturi-injector having an ozone suction port, a water inlet port, and an outlet port, wherein the water inlet port is plumbed to the water source, the ozone suction port is plumbed to the ozone generator, and the outlet port is plumbed to provide an ozonated liquid stream to the drum;
(d) a secondary injection device configured to provide ozone to the liquid wash bath; and
(e) an ozone control system (OCS) in communication with the ozone generator and the washing machine, wherein the OCS is configured to
provide ozone to the Venturi-injector when the washing machine is in the fill configuration, and
provide ozone to the secondary injection device when the washing machine is in the wash configuration,
wherein the system is able to maintain an aqueous ozone concentration in the drum for a duration.

2. The system of claim 1, wherein
the aqueous ozone concentration, as determined by an empty run, is in the range of about 0.3 ppm to about 2.0 ppm, and
the duration is in the range of about 3 minutes to about 15 minutes.

3. The system of claim 1, further including the liquid wash bath, wherein the aqueous ozone concentration in the wash bath, as determined by an empty run, is in the range of about 0.4 ppm to about 1.3 ppm, the duration is in the range of about 4 minutes to about 15 minutes, and off gas measurements are safe.

4. The system of claim 1, including
a first signal generator configured to generate a first signal (S1) when the washing machine is in the start configuration,
a second signal generator configured to generate a second signal (S2) to initiate the fill configuration, and
a signal interrupter configured to interrupt S1 when S2 is generated.

5. The system of claim 4, wherein the OCS includes at least one signal receiver configured to receive S1 and S2.

6. The system of claim 5, wherein
the signal interrupter blocks S1 from reaching the OCS in the start configuration,
the ozone generator generates ozone and supplies ozone to the Venturi-injector at a first level when the OCS receives the second signal (S2), and
the ozone generator generates ozone and supplies ozone to the secondary injection device at a second, lower level when the signal interrupter is turned off.

7. The system of claim 6, wherein the drain configuration is established by turning off S1.

8. The system of claim 6, wherein the first signal generator is in communication with sensor configured to detect the operation of a drain valve, the second signal generator is in communication with a sensor configured to detect the flow of liquid to the wash drum, and the signal interrupter is in communication with a vacuum sensor.

9. The system of claim 6, further including a third signal generator configured to generate a third signal (S3) to initiate the drain configuration, and wherein the OCS signal receiver is configured to receive S3.

10. The system of claim 1, wherein the secondary injection system includes at least one of a diffuser and a side-arm injector,
wherein the diffuser has an ozone inlet port and an ozone outlet port, wherein the ozone outlet port is positioned to diffuse ozone into the liquid wash bath positioned within the drum, and
wherein the side-arm injector includes a Venturi-injector including an ozone suction port, a water inlet port, and an outlet port, wherein the water inlet port is plumbed to the liquid wash bath, the ozone suction port is plumbed to the ozone generator, and the outlet port is plumbed to provide an ozonated liquid stream back to the liquid wash bath.

11. The system of claim 4, wherein the first signal generator is in communication with at least one of a sensor and a logic step.

12. The system of claim 11, wherein
the sensor is configured to detect the operation of at least one of a power switch, a start switch, and closing a drain valve, and
the logic step is initiated by at least one of establishing a start configuration, operation of a power switch, operation of a start switch, and closing of a drain valve.

13. The system of claim 11, wherein the first signal generator includes a first relay.

14. The system of claim 2, wherein the second signal generator is in communication with at least one of a sensor and a logic step.

15. The system of claim 14, wherein
the sensor in communication with the second signal generator is also in communication with at least one of a feeding valve, a flow switch and a pressure switch, and
the logic step in communication with the second signal generator is initiated by actuation of a feeding valve.

16. The system of claim 15, wherein the second signal generator includes a second relay.

17. The system of claim 4, wherein the signal interrupter is in communication with at least one of a sensor, a logic step, S1 and S2.

18. The system of claim 17, wherein
the sensor in communication with the signal interrupter is also in communication with at least one of a feeding valve, a flow switch, an agitator, and a drum rotator, and
the logic step in communication with the signal interrupter is initiated by at least one of actuation of a feeding valve, operation of an agitator, and operation of a drum rotator.

19. The system of claim 17, wherein the signal interrupter includes at least one of
a latch relay and
a normally closed relay.

20. The system of claim 8, wherein the third signal generator is in communication with at least one of a sensor and a logic step.

21. The system of claim 20, wherein
the sensor in communication with the third signal generator is also in communication with a drain valve,
the logic step in communication with the third signal generator is initiated by opening of a drain valve, and
the third signal generator includes a forth relay.

22. The system of claim 1, further including a valve-actuation signal generator configured send a valve actuation signal (VAS) to actuate at least one valve plumbed between the ozone generator and the washing machine.

23. The system of claim 22, wherein the at least one valve includes a 3-way valve having an input and a first and a second actuatable outputs, wherein
the first actuatable output is plumbed to the ozone suction port of the Venturi-injector,
the second actuatable output is plumbed to the ozone inlet port of the secondary injection device.

24. An ozone laundry system configured to receive water from a water source, the system comprising:
(a) a washing machine having
a vented drum for holding laundry and a liquid wash bath, and
a plurality of operational configurations including a start configuration, a fill configuration, a wash configuration, and a drain configuration,
wherein the washing machine includes
a first signal generator configured to generate a first signal (S1) when the washing machine is in the start configuration,
a second signal generator configured to generate a second signal (S2) to initiate the fill configuration, and
a signal interrupter configured to interrupt S1 when S2 is generated;
(b) an ozone generator including at least one ozone cell;
(c) a Venturi-injector having an ozone suction port, a water inlet port, and an outlet port, wherein the water inlet port is plumbed to the water source, the ozone suction port is plumbed to the ozone generator, and the outlet port is plumbed to provide an ozonated liquid stream to the drum;
(d) a secondary injection device configured to provide ozone to the liquid wash bath; and
(e) an ozone control system (OCS) in communication with the ozone generator and the washing machine, wherein the OCS includes at least one signal receiver configured to receive at least one of S1 and S2, wherein the ozone generator and the OCS are arranged such that
the signal interrupter blocks S1 from reaching the OCS in the start configuration
the ozone generator generates ozone and supplies ozone to the Venturi-injector when the OCS receives the second signal (S2) in an amount sufficient to allow the Venturi-injector to provide an aqueous ozone concentration in a range of about 0.8 ppm to about 2.5 ppm,
the ozone generator supplies ozone to the secondary injection device at a second, lower level in a range of 0.25% to about 5%, by weight of gas, when the signal interrupter is turned off, and
stops the supply of ozone when the first signal generator is no longer generating S1,
wherein the system is able to maintain an aqueous ozone concentration in the drum, as determined by an empty run, in the range of about 0.4 ppm to about 1.3 ppm for a duration in the range of about 4 minutes to about 15 minutes.

26. A method of creating an ozone laundry system, the method comprising:
obtaining a washing machine having a vented drum for holding laundry and a liquid wash bath, and
creating plurality of operational configurations including a start configuration, a fill configuration, a wash configuration, and a drain configuration;
installing a first signal generator configured to generate a first signal (S1) to initiate the start configuration;
installing a second signal generator configured to generate a second signal (S2) to initiate the fill configuration;
providing an ozone generator including at least one ozone cell and at least one power supply in communication with the at least one ozone cell;
installing a Venturi-injector having an ozone suction port, a water inlet port, and an outlet port, wherein installing includes plumbing the water inlet port to the water source, plumbing the ozone suction to the ozone generator, and plumbing the outlet port to provide an ozonated liquid stream to the drum;
installing a secondary injection device configured to provide ozone to the liquid wash bath; and
interfacing an ozone control system (OCS) in communication with the ozone generator with the washing machine, wherein the OCS includes at least one signal receiver configured to receive S1 and S2.

27. A method of laundering items, the method comprising:
(a) providing a washing machine having
a vented drum for holding laundry and a liquid wash bath, and
a plurality of operational configurations including a start configuration, a fill configuration, a wash configuration, and a drain configuration;
(b) providing an ozone control system (OCS) in communication with an ozone generator and the washing machine;
(c) providing ozone to a Venturi-injector when the washing machine is in the fill configuration;
(d) providing ozone to a secondary injection device when the washing machine is in the wash configuration; and
(e) maintaining an aqueous ozone concentration in the drum, as determined by an empty run, in the range of about 0.4 ppm to about 1.3 ppm for a duration in the range of about 4 minutes to about 15 minutes.
